(19) United States
(12) Patent Application Publication
(10) Pub. No.: US 2023/0089349 A1
(43) Pub. Date: Mar. 23, 2023

(54) Computer Architecture with Register Name Addressing and Dynamic Load Size Adjustment

(71) Applicant: Wisconsin Alumni Research Foundation, Madison, WI (US)

(72) Inventors: Gurindar Singh Sohi, Madison, WI (US); Vanshika Baoni, Santa Clara, CA (US); Adarsh Mittal, Santa Clara, CA (US)

(21) Appl. No.: 17/480,879

(22) Filed: Sep. 21, 2021

(51) Int. Cl. G06F 9/30; G06F 9/38; G06F 12/1027

(52) U.S. Cl. CPC G06F 9/30043; G06F 9/3806; G06F 9/3826; G06F 9/30105; G06F 12/1027

(57) ABSTRACT

A computer architecture allows load instructions to fetch from cache memory “fat” loads having more data than necessary to satisfy execution of the load instruction, for example, loading a full cache line instead of a required word. The fat load allows load instructions having spatiotemporal locality to share the data of the fat load avoiding cache accesses. Rapid access to local data structures is provided by using base register names to directly access those structures as a proxy for the actual load base register address,

STATEMENT REGARDING FEDERALLY SPONSORED RESEARCH OR DEVELOPMENT

CROSS REFERENCE TO RELATED APPLICATION

### BACKGROUND OF THE INVENTION

The present invention relates to computer architectures employing cache memory hierarchies and in particular to an architecture that provides fast local access to data optionally permitting loading different amounts of data from the cache based on a prediction.

Computer processors executing a program tend to access data memory locations that are close to each other for instructions that are executed at proximate times. This phenomenon is termed spatiotemporal locality and has brought about the development of memory hierarchies having one or more cache memories coordinated with the main memory. Generally, each level of the memory hierarchy employs successively smaller but faster memory structures as one proceeds from a main memory to a lowest level cache. The time penalty in moving data through the hierarchy from larger, slower structures to smaller, faster structures is acceptable as it is typically offset by many higher speed accesses to the smaller, faster structure, as is expected with the spatiotemporal locality of data.

### SUMMARY

The operation of a memory hierarchy can be improved, and the energy expended in accessing the memory hierarchy reduced, by using a larger data load size, particularly when loaded data is predicted to have high spatiotemporal locality. This larger load can be stored in efficient local storage structures to avoid subsequent slower and more energy intensive cache loads. The dynamically changing spatiotemporal locality of data is normally not known at the time of the load instruction, however, the present inventors have determined that imperfect yet practical dynamic estimates of spatiotemporal locality significantly improve the ability to exploit such spatiotemporal locality by allowing larger or more efficient storage structures based on predictions of which data is likely to have the most potential reuse. Importantly, the benefit of selectively loading larger amounts of data (fat loads) is not lost even when the estimates of spatiotemporal locality are error-prone because such a system can “fail gracefully” allowing a normal cache load, or alternatively discarding extra cache load data that is unused, if spatiotemporal locality is not correctly anticipated.

A second aspect of the present invention provides earlier access to data in local storage structures by accessing the storage structures using only the names of base registers and not the register contents greatly accelerating the ability to access the storage structures. This approach can be used either alone or with the fat loads described above. Earlier access of data from local storage structures provide significant ancillary benefits including earlier resolution of mispredicted branches and reduced wrong-path instructions.

More specifically, in one embodiment the invention provides a computer processor operating in conjunction with a memory hierarchy to execute a program. The computer processor includes processing circuitry operating to receive a first and a second load instruction of a type specifying a load operation loading a designated data from a memory region of the memory hierarchy to the processor. The processing circuitry may operate to process the first load instruction by loading from the memory hierarchy the designated data of the first load instruction to the processor and to process the second load instruction by loading from the memory hierarchy a “fat load” of data greater in amount than an amount of designated data of the second load instruction to the processor.

It is thus a feature of at least one embodiment of the invention to provide a compact (and hence fast) local storage structure by selectively loading additional data to the processor only for load instructions likely to exhibit high spatiotemporal locality.

In one embodiment, the architecture may include a prediction circuit operating to generate a prediction value predicting spatiotemporal locality of the data to be loaded by the first load instruction and the second load instruction. Using this prediction value, the processing circuitry may select between a loading from the memory hierarchy of the designated data and a fat load of data based on the prediction values for the first and second load instruction received from the prediction circuit.

It is thus a feature of at least one embodiment of the invention to permit the use of a small storage structure by predicting likely reuse of data and selecting data for storage based on this prediction. This ability is founded on a determination that meaningful predictions of spatiotemporal locality can be made for important classes of computer programs.

The prediction circuit may provide a prediction table linking multiple sets of prediction values and load instructions.

It is thus a feature of at least one embodiment of the invention to effectively leverage a small and fast storage structure by exploiting a persistent association between particular load instructions and spatiotemporal locality.

The prediction circuit may operate to generate the prediction value by monitoring spatiotemporal locality for previous executions of load instructions.

It is thus a feature of at least one embodiment of the invention to exploit a linkage between historical and future spatiotemporal locality for load instructions determined by the inventors to exist in many important computer programs.

The prediction circuit may access the prediction table to obtain a prediction value for a load instruction using the program counter value of the load instruction.

It is thus a feature of at least one embodiment of the invention to rapidly assess the spatiotemporal locality associated with a given load instruction. This ability relies on a determination by the present inventors that there is a meaningful variation in spatiotemporal locality identifiable to particular load instructions.

The prediction circuit, in one embodiment, may use a compressed representation of the program counter insufficient to map to a unique program counter value to access the prediction table.

It is thus a feature of at least one embodiment of the invention to allow a flexible trade-off between table size and prediction accuracy by compressing the program counter value range. Simulations have demonstrated that the probabilistic nature of the prediction process can accommodate errors introduced by compression of this kind.

The prediction value for a given load instruction may be based on a measurement of a number of subsequent load instructions accessing a same memory region as the given load instruction in a measurement interval.

It is thus a feature of at least one embodiment of the invention to provide a simple method of tailoring the historical measurement to an expected decrease in the predictive power of older measurements through a deterministic measurement interval.

In some nonlimiting examples, measurement interval can be: (a) a time between an execution of a given load and a completion of processing of the given load instruction; or (b) a number of instructions executing subsequent to the execution of the given load instruction; or (c) a number of clock cycles of the computer processor after the execution of the given load instruction, where execution of the given load instruction corresponds to a time of determination of the memory region to be accessed by the given load instruction.

It is thus a feature of at least one embodiment of the invention to flexible measurement interval definition that may accommodate different architectural goals or limitations.

The computer processor may further include a translation lookaside buffer holding page table data used for translation between virtual and physical addresses and the processing circuitry may process the second load instruction to load both the fat load of data and translation lookaside buffer data to the processor.

It is thus a feature of at least one embodiment the present invention to employ the same local storage techniques to reduce access time to the translation lookaside buffer.

The processing circuitry may receive a third load instruction and process the third load instruction by providing designated data for the third load instruction to the processor from the fat load of data of the second instruction. This third load instruction may be associated with an offset with respect to its base register and in this case the processing circuitry may compare an offset of the third instruction to a location in the fat area of the storage structure linked in the mapping table to confirm that the fat load of data of the second load instruction contains the designated data of the third load instruction.

It is thus a feature of at least one embodiment of the invention to provide a mechanism that allows later load instructions to quickly identify the data they need from within a fat load. By evaluating the offsets and base register names only, delays incident to decoding the load address by reading the contents of the base register can be avoided.

Each fat load area of storage structures may be made up of a set of named ordered physical registers and location in the fat load area may be designated by a name of one of the set of named ordered physical registers.

It is thus a feature of at least one embodiment of the invention to provide a simple direct accessing of the fat load data using register names.

The processing circuitry may include a register mapping table mapping an architectural register to a physical register and the processing circuitry may change the register mapping table to link the selected physical register holding the designated data for the third load instruction to a destination register of the third load instruction.

It is thus a feature of at least one embodiment of the invention to avoid a time-consuming register-to-register transfer of data by employing a simple re-mapping of the architectural register.

The data in a fat load area may be linked with a count value indicating an expected spatiotemporal locality of the fat load of data with respect to future load instructions and the architecture may operate to update the count value to indicate a reduced expected remaining spatiotemporal locality when the third load instruction is processed by the processing circuitry in providing its designated data from the data in the fat load area.

It is thus a feature of at least one embodiment of the invention to efficiently conserve limited local storage resources (permitting a small, fast storage structure) by adopting a replacement policy by using a prediction value (which may be the same prediction value that determines whether to make a fat load) to assess the future value of the stored data in satisfying later load instructions.

In one nonlimiting example, the amount of the designated data may be a memory word and the amount of the fat load data may be at least a half-cache line of a lowest level cache in the memory hierarchy.

It is thus a feature of at least one embodiment of the invention to provide a system that integrates well with current computer architectures employing cache structures.

In one embodiment, the invention provides a computer architecture having processing circuitry operating to receive a load instruction of a type providing a name of a base register holding memory address information of designated data for the load instruction. A mapping table links the name of a base register of a first load instruction to a storage structure holding data derived from memory address information of the base register of the first load instruction. The processing circuitry further operates to match a name of a base register of a second load instruction to a name of a base register in the mapping table to determine if the designated data for the second load instruction is available in a storage structure.

It is thus a feature of at least one embodiment of the invention to provide an extremely rapid method of identifying the availability of locally stored data for load instructions by evaluating the name of the base register of the load instruction rather than the base register contents.

These objects and advantages may apply to only some embodiments falling within the claims and thus do not define the scope of the invention.

### BRIEF DESCRIPTION OF THE DRAWINGS

FIG. 1 is an architectural diagram of a processor employing the present invention showing processor components including a predictive load processing circuit and a memory hierarchy including an L1 cache;

FIG. 2 is a diagram showing an access pattern for a group of contemporaneous load instructions exhibiting a spatiotemporal locality;

FIGS. 3a-3c are flowcharts describing operation of the predictive load processing circuit of FIG. 1, as part of a processor’s instruction processing circuitry, in predicting data reuse and in using that prediction to control an amount of data to be loaded from the cache in executing load instructions;

FIG. 4 is a logical representation of a contemporaneous region access count table (CRAC) used to collect statistics about spatiotemporal loads in real time;

FIG. 5 is a logical representation of a contemporaneous load access prediction table (CLAP) holding the statistics developed by the CRAC for future execution cycles;

FIG. 6 is a logical representation of a contemporaneous load access register map table (CMAP) used to determine whether fat load data exists;

FIG. 7 is a logical representation of a set of contemporaneous load access registers (CLAR) used to hold fat load data;

FIG. 8 is a flowchart describing operation of the predictive load processing circuit of FIG. 1 in monitoring register modifications;

FIG. 9 is a flowchart describing operation of the predictive load processing circuit of FIG. 1 during store operations;

FIG. 10 is a figure similar to FIG. 1 showing an architecture independent of the predictive load processing circuitry of FIG. 1 while providing register name addressing, for example, also used in the embodiment of FIGS. 6 and 7;

FIG. 11 is a figure similar to that of FIG. 6 showing an alternative version of the CMAP also fulfilling functions of a register mapping table;

FIG. 12 is a figure similar to that of FIG. 7 showing a set of physical registers used for the CLAR; and

FIG. 13 is a figure similar to that of FIG. , 3 showing a simplified access to the CLAR without prediction.

### DETAILED DESCRIPTION

### System Hardware for Predictive Loading

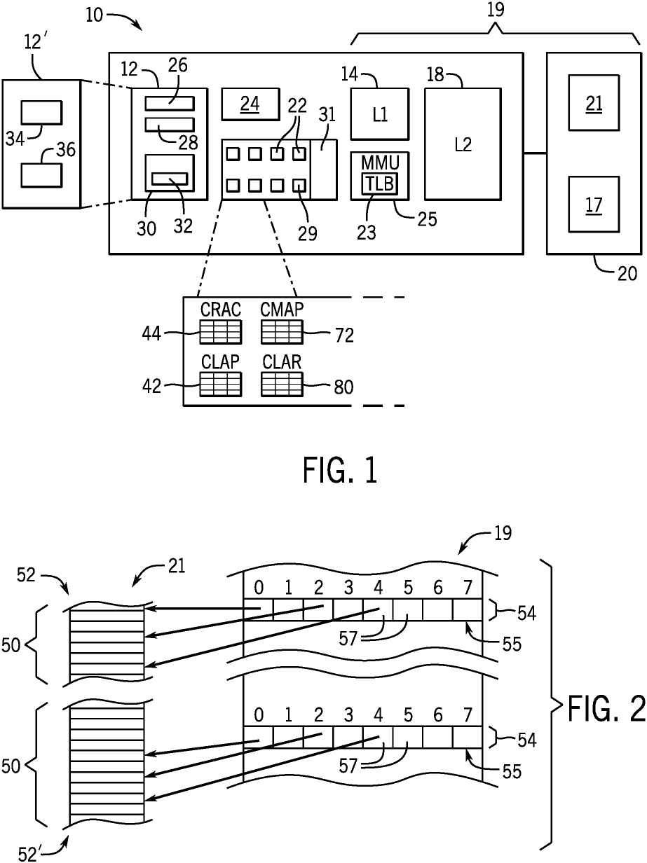

Referring now to FIG. 1, in one embodiment, the present invention may provide a processor 10 providing a processor core 12, an L1 cache 14, and an L2 cache 18 communicating with an external memory 20, for example, including banks of RAM, disk drives, etc. As is understood in the art, the various memory elements of the external memory 16, the L2 cache 18, and the L1 cache 14 together form a memory hierarchy 19 through which data may be passed for efficient access. Generally, the memory hierarchy 19 will hold a program 21 including multiple instructions to be executed by the processor 10 including load and store instructions. The memory hierarchy 19 may also include data 17 that may be operated on by the instructions.

Access to the memory hierarchy may be mediated by a memory management unit (MMU) 25 which will normally provide access to a page table (not shown) having page table entries that provide a mapping between virtual memory addresses and physical memory addresses, memory access permissions, and the like. The MMU may also include a translation lookaside buffer (TLB) 23 serving as a cache of page table entries to allow high-speed access to entries of a page table.

In addition to the processor core 12 and the L1 cache 14, processor 10 may also include various physical registers 22 holding data operated on by the instructions as is understood in the art including a specialized program counter 29 used to identify instructions in the program 21 for execution. A register mapping table 31 may map various logical or architectural registers to the physical registers 22 as is generally understood in the art. These physical registers 22 are local to the processor core 12 and architected to provide much faster access than provided by access to the L1 cache.

The processor 10 will also provide instruction processing circuitry in the form of a predictive load processing circuit 24 as will be discussed in more detail below and which controls a loading of data from the L1 cache 14 for use by the processor core 12. In most embodiments, the processor core 12, caches 14 and 18, physical registers 22, program counter 29, and the predictive load processing circuit 24 will be contained on a single integrated circuit substrate with close integration for fast data communication.

In one embodiment, the processor core 12 may provide an out-of-order (OOO) processor of the type generally known in the art having fetch and decode circuitry 26, a set of reservation stations 28 holding instructions for execution, and a commitment circuit 30 ordering the instructions for commitment according to a reorder buffer 32, as is understood in the art. Alternatively, and as shown in inset in FIG. 1, the invention may work with a general in-order processor core 12' having in-order fetch and decode circuits 34 and execution circuits 36 executing instructions in order without reordering.

Referring still to FIG. 1, the predictive load processing circuit 24 may include a firmware and/or discrete logic circuit whose operation will be discussed in more detail below, to load information from the L1 cache 14 to a contemporaneous load access register (CLAR) 80 being part of the predictive load processing circuit 24. Generally, access by the processor core 12 to the CLAR 80 will be substantially faster and consume less energy than access by the processor core 12 to the L1 cache 14 which is possible because of its smaller size and simpler architecture.

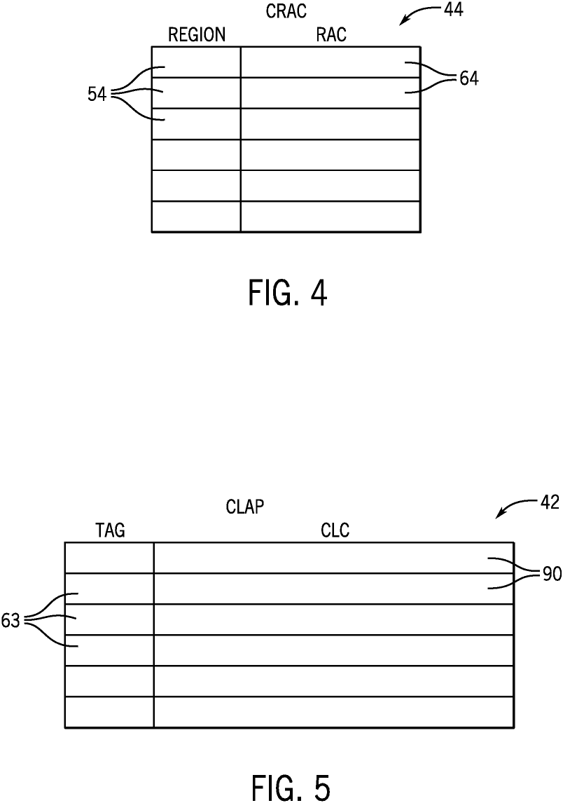

Whether data for a given load instruction is loaded into the CLAR 80 by the predictive load processing circuit 24 may be informed by a contemporaneous load access prediction table (CLAP) 42 (shown in FIG. 5) that serves to predict the spatiotemporal locality that will be associated with that load instruction and subsequent contemporaneous load instructions. The prediction value of the CLAP 42 is derived from data collected by a contemporaneous region access count table (CRAC) 44 (shown in FIG. 4) that monitors the executing program 21 as will be discussed.

Referring now to FIG. 2, sets of instructions 50 of the program 21 having high spatiotemporal locality will, when executed at different times 52 and 52', include contemporaneous load instructions that access common regions 54 (contiguous ranges of memory addresses or memory regions) in the memory hierarchy 19. For simplicity, the common regions 54 as depicted and discussed can be a cache line, but other region sizes are also contemplated including part of a cache line or even several cache lines. Note that the common regions 54 may have different starting addresses at the different times 52 and 52', and thus the commonality refers only to a given time of execution of the set of instructions 50. The present invention undertakes to identify a load instruction accessing a region 54 associated with high spatiotemporal locality and process it to optimize the loading of data from the region from the memory hierarchy 19 into a CLAR 80, from where other contemporaneous load instructions in the set could access the data with greater speed and lower energy than accessing the data from the memory hierarchy 19.

In this regard, the present inventors have recognized that although the amount of spatiotemporal locality of sets of instructions in different programs or even different parts of the same program 21 will vary significantly, a significant subset of instructions 50 have persistent spatiotemporal locality over many execution cycles. Further, the present inventors have recognized that spatiotemporal locality can be exploited successfully with limited storage of predictions, for example, in the table having relatively few entries, far less than the typical number of instructions in a program 21 and a necessary condition for practical implementation. Simulations have validated that as few as 128 entries may provide significant improvements in operation and for this reason it is expected that a table size of less than 512 or less than 2000 would likewise provide substantial benefits, although the broadest concept of the invention is not limited by these numbers. For the purpose of simplifying the following discussion, as noted above, in one embodiment the common region 54 will be considered a cache line 55 (as represented) having at various offsets within the cache line eight words 57 that individually may be a data argument for a load instruction. In the following example, upon occurrence of a load instruction, the predictive load processing circuit 24 makes a decision whether to load a given word 57 from CLAR 80 (a “Load-CLAR” ) or to load the word 57 from the memory hierarchy 19 (a “Load-Normal” from the L1 cache 14) as required by the load instruction or load the entire cache line 55 including data not required by the given load instruction (a “Fat-Load”) with the expectation that there is a substantial spatiotemporal locality associated with that cache line 55 so that subsequent load instructions accessing this same cache line 55 may obtain their data from CLAR 80.

### Data Structure and Operation

### Developing Predictions of Spatiotemporal Locality

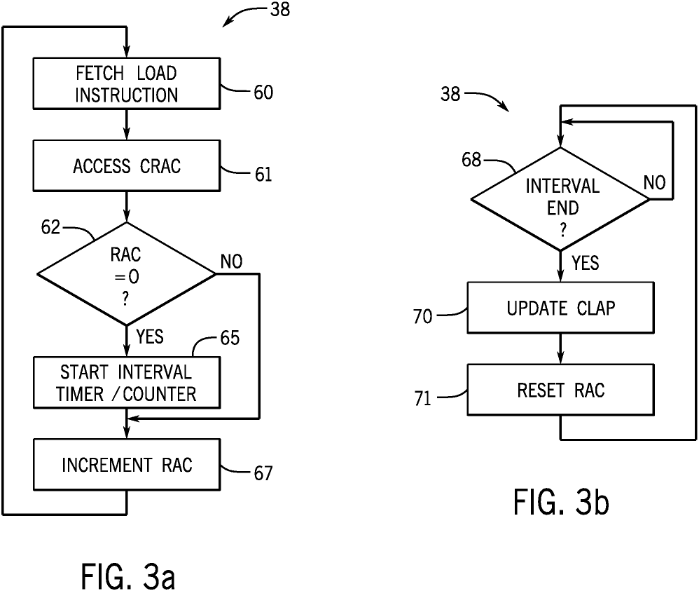

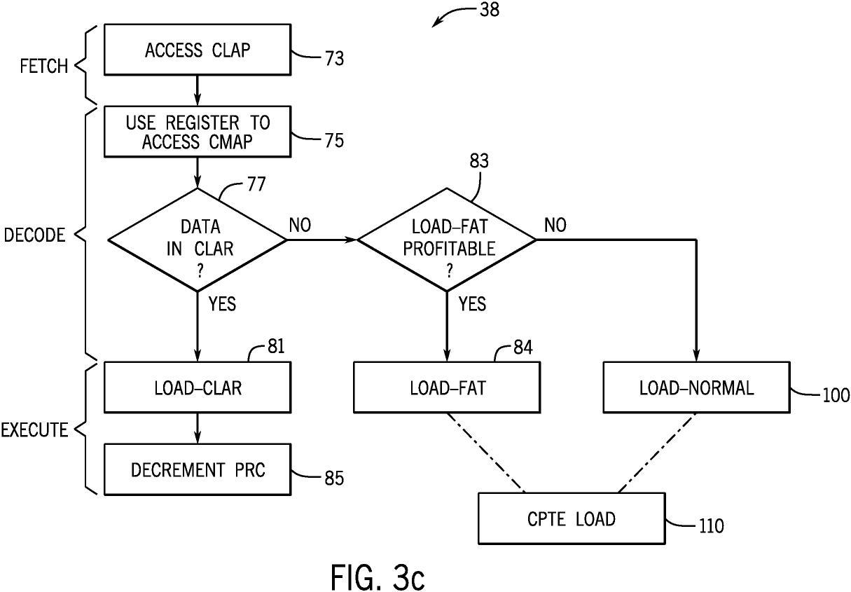

Referring now to FIG. 3a, the predictive load processing circuit 24 implementing the firmware 38, in communication with processor core 12 and its instruction processing circuitry, may monitor the processing of a load instruction at the processor core 12 per process block 60 and may use the lower order bits of the memory address for the data accessed by the load instruction to access the CRAC 44 per process block 61. The CRAC 44 (shown in FIG. 4) provides a logical table having a set of rows corresponding in number to a number of cache lines 55 in the L1 cache 14 and more generally to a number of predefined regions 54 in the L1 cache 14.

Once the proper row of the CRAC 44 is identified using the low order address bits, a corresponding region access count (RAC) 64 for that row is checked per decision block 62. The RAC 64 generally indicates the number of contemporaneous load instructions that have accessed that region 54 or cache line 55 of that row during a current measurement interval, as will be discussed.

If the RAC 64 is zero, as determined at decision block 62, there is no ongoing measurement interval for the given cache line 55 and the given load instruction is a first load instruction of a new measurement interval accessing that cache line 55. Accordingly, at that time the new measurement interval is initiated per process block 65 to collect information about the spatiotemporal locality of the region that is being accessed by the given first load instruction, and the given first load instruction is marked as a potential fat load candidate instruction. In an out-of-order processor core 12, this flagging may be accomplished in the reorder buffer by setting a potential fat load candidate bit (PFLC) associated with that load instruction, while in an in-order processor core 12', a dedicated flag for the instruction may be established.

The new measurement interval initiated at process block 65 may employ a variety of different measurement techniques including counting instructions, time, or occurrences of different processing states of the load instruction, for example, terminating at its retirement, or a combination of different measurement techniques. In some nonlimiting examples, the interval may be (a) a time between the execution of the given load and the completion of processing of the given load instruction; or (b) a number of instructions executing subsequent to the execution of the given load instruction; or (c) a number of clock cycles of the computer processor after the execution of the given load instruction where execution of the given load instruction corresponds to a time of determination of the memory region to be accessed by given load instruction. An appropriate counter or clock (not shown) associated with each region 54 may be employed for this purpose.

At a next process block 67 (whether the given load instruction is the first or a subsequent load instruction during the measurement interval), the RAC 64 (discussed above) for the identified row of the CRAC 44 is incremented indicating a load instruction accessing the given cache line 55 has been encountered in the execution of the program during the ongoing measurement interval.

Referring now to FIG. 3b, at the expiration of the measurement interval for a given first load instruction marked as a potential fat load candidate instruction, triggered by any of the mechanisms discussed above and as indicated by decision block 68, the information accumulated in the CRAC 44 will be used to update the CLAP 42 providing a longer-term repository for historical data about the spatiotemporal locality, per process block 70. At this time, the value of RAC 64 in the CRAC 44 associated with a given first load instruction indicates how many later load instructions accessed the same cache line 55 from the memory hierarchy 19 in the measurement interval. This value of the RAC 64 minus one is moved to the corresponding contemporaneous load count (CLC) 90 of the CLAP 42 in a row indexed by the bits of the program counter 29 for the given first load instruction, and the value of the RAC 64 in the CRAC 44 is then set to zero per process block 71. The CLAP 42 thus provides in its CLC values a predicted spatiotemporal locality for a set of first load instructions for given regions 54.

While the number of possible first load instructions in the program 21 may be quite large, the present inventors have determined that the invention can be beneficially implemented with a relatively small CLAP 42, for example, having 128 entries and in most cases less than 2000 entries, far less than the number of load instructions that are found in a typical program 21. In one embodiment, the rows of the CLAP 42 may be indexed by only the low order bits of the program counter. This will beneficially reduce the size of the CLAP but will also result in an “aliasing” of different program counter values to the same row. The aliasing may be addressed by providing a tag 63, with a different number of bits in the tag addressing the aliasing to different degrees. In one embodiment of the invention, this aliasing is left unresolved and empirically appears to result in only a small loss of performance that is overcome by the general advantages of the invention. In another embodiment, the bits are used to index and select a row in the CLAP 42 and, for the tag, could be function of a subset of the bits of the program counter 29 for the load instruction and other additional bits of information. Note that an incorrect prediction of spatiotemporal locality simply results in different fat loads but will not produce incorrect load values because of other mechanisms to be described. The development of the CLC 90 of the CLAP 42 will be discussed in more detail below.

### Using Spatiotemporal Locality Predictions

The prediction values of the CLC 90 in the CLAP 42 will be used to selectively make a load instruction from the L1 cache 14 into a fat load instruction from the L1 cache 14 to the CLAR 80 when that data is likely to be usable for additional subsequent load instructions.

This process begins as indicated by process block 73 of FIG. 3c with the fetching of a load instruction and thus may occur contemporaneously with the steps of FIG. 3a discussed above. At this step a set of bits is used to index the CLAP 42 and select a row to obtain the CLC 90. In one embodiment, the rows of the CLAP 42 may be indexed by only the low order bits of the program counter of the load instruction. More generally, the bits used to index and select a row in the CLAP 42 could be any function resulting in a reduced subset of the bits of the program counter 29 for the load instruction (for example, a hash function or other deterministic compressing function). In general, using a subset of the bits of the program counter 29 of a load instruction will resulting in “aliasing,” where the value of the CLC 90 is shared by multiple load instructions.

Generally, the load instruction will have a base address described by the contents of a base architectural register (which may either be a physical register 22 or mapped to a physical register 22 by the register mapping table 31) and possibly a memory offset describing a resulting target memory address offset from the base address as is generally understood in the art. During a decode process of the received load instruction, per process block 75, the load instruction’s base register may be identified and its name (rather than its contents) used to access CMAP 72. Significantly, this ability to access the CMAP 72 without reading the contents of the base register or otherwise decoding the memory address in the base register greatly accelerates access to the data in the CLAR 80.

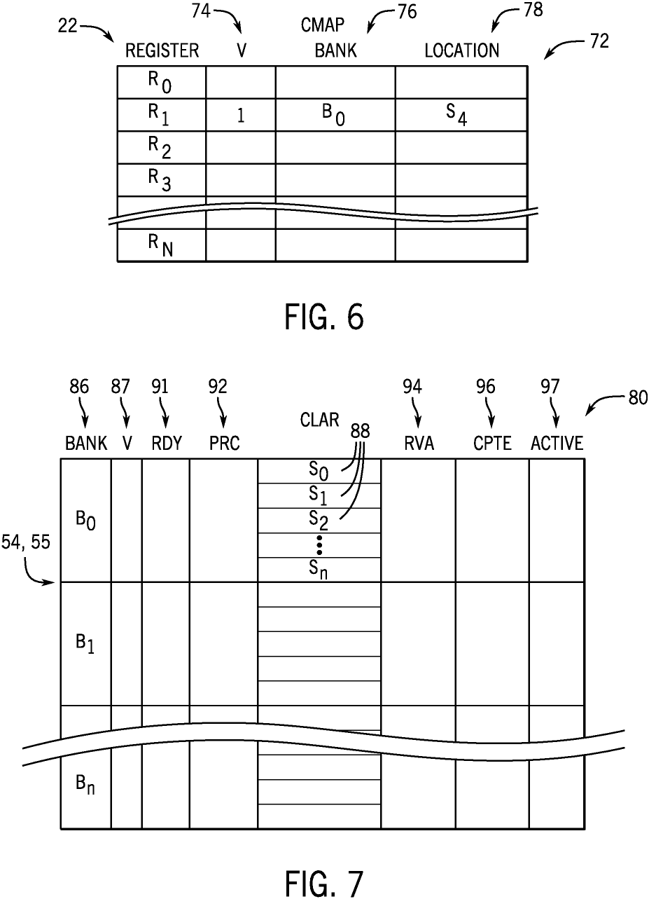

Referring momentarily to FIG. 6, the CMAP 72 provides a logical row for each architectural register (R₀-R_{N}) of the processor 10. Each row has a valid bit 74 indicating that the row data is valid. Each row also indicates a bank 76 and provides a storage location identifier 78. The bank 76 maps to a single row of the CLAR 80 which is sized to hold the data of a region 54 (e.g., the entire cache line 55) fetched by a fat load. The storage location identifier 78 identifies a storage structure 88 within the CLAR row which holds the data of the memory address contained in the base architectural register of the load instruction previously providing the data for the CLAR row. As will be discussed, the bank 76 and storage location identifier 78 may be used to determine whether (and in fact confirm that) the necessary data of the load target memory address for a later load instruction is in the CLAR 80, allowing that data to be obtained from the CLAR 80 instead of the L 1 cache 14.

Referring now momentarily to FIG. 7, the CLAR 80 provides a number of logical rows (for example, 4) indexable by bank 76. Each row will be mappable to a region 54 (e.g., a cache line 55) and for that purpose provides a set of storage structures 88 equal in number to the number of individual words 57 of a region 54 so that, in this example, storage structures 88 labeled s0-s7 may hold the eight words 57 of a cache line 55. Using the bank 76 and storage location identifier 78 from the CMAP 72 and the memory offset of the load instruction, the appropriate storage structure 88 in CLAR 80 can be directly accessed to obtain the necessary data for the load instruction by passing the L1 cache 14.

The CLAR 80 may also provide a set of metadata associated with the stored data including a ready bit 91 (which must be set before data is provided to the load instruction) and a pending remaining count value PRC 92 which is decremented when data is provided to a load instruction from the CLAR 80 as will be discussed below. Generally, the PRC provides an updated prediction of spatiotemporal locality for the given cache line 55 in the storage structures 88 as will be discussed below. At each access to a given line 55 of the CLAR 80, its associated PRC is decremented being a measure of the remaining value of the stored information with respect to servicing load instructions.

The CLAR 80 may also provide a region virtual address RVA 94 indicating the virtual address corresponding to the stored cache line 55 in the storage structures 88 and a corresponding page table entry (CPTE) 96 holding the page table entry from the translation lookaside buffer 23 related to the address of the data of the storage structures 88. Finally, the CLAR 80 will hold a valid bit 87 (indicating the validity of the data of the row) and an active count 97 indicating any in-flight instructions that are using the data of that row. The active count 97 is incremented when any Load-CLAR (to be discussed below) is dispatched and decremented when the Load-CLAR is executed.

Continuing at decision block 77 of FIG. 3c, the memory offset of the current load instruction is compared to the storage location identifier 78 of the indicated row of the CMAP 72 (corresponding to the base register of the current load instruction) to see if these two values are consistent with the target memory address of the current load instruction (of process block 73) being in a common cache line 55 (region 54) with the data stored in the CLAR 80. If the valid bit 74 of the CMAP 72 is set, it may be assumed that the base register of the current load instruction has the address of the data stored in the identified row of the CLAR 80 for that base register. So, for example, where the location entry in the CMAP 72 is s4, the memory data for a current load instruction of the form of LOAD R_{dest}, R_{base}-4 has an offset value of -4, that is a load instruction that is loading from a memory address obtained by subtracting 4 from the contents of base register R_{base}, can be assumed to also be in the CLAR 80 because s4-4=s0, an offset that falls within a single cache line 55 with the word s4 (a cache line has each word/location s0-s7). On the other hand, if the current load instruction is in the form of LOAD R_{dest}, R_{base}+5 having an offset value of +5, it can be assumed that the desired load data is not in the CLAR 80 because ₛ4+5=s9, an address that falls outside of the cache line 55 previously brought in for storing s4 (but rather falls in the next cache line 55).

Importantly, upon interrogating the CMAP 72, it is known immediately whether the necessary data is in the CLAR 80 providing a significant advantage in the execution of data-dependent instructions, as the availability of data for the later data-dependent instruction in the CLAR 80 will have been resolved at the interrogation of the CMAP 72 before later dependent data instructions are invoked. Notably, this determination is made simply using the base register name and the memory offset of the load instruction without requiring knowledge of the contents of the base register greatly accelerating this determination.

### Load-CLAR

If, after review of the CMAP 72 at decision block 77, the determination is that the necessary data of the memory addresses of a load instruction is in the CLAR 80, then per process block 84 the necessary data is read directly from the CLAR 80 and the load instruction is termed a “Load-CLAR.” Such a Load-CLAR instruction can obtain its data from the CLAR 80 and need not access the L1 cache 14. During instruction execution per process block 81, whenever data for a load instruction is read from the CLAR 80, the PRC 92 for the appropriate line of the CLAR 80 matching the bank 76 is decremented at process block 85 as mentioned above to provide a current indication of the expected number of additional loads that will be serviced by that data. This is used later in executing a replacement policy for the CLAR 80.

The Load-CLAR, unlike a load from the L1 cache, executes with a fixed, known latency, allowing dependent operations to be scheduled deterministically rather than speculatively.

### Load-Fat

Ifat decision block 77, the necessary data is not in the CLAR 80, the program moves to decision block 83 which determines whether a Load-Fat (e.g., a cache line 55) or Load-Normal (e.g., a cache word 57) should be implemented. In decision block 83, the CLC 90 from the appropriate row of CLAP 42 obtained for the load instruction in process block 73 is compared to each of the PRC values of the CLAR 80. If the CLC 90, which indicates the expected number of loads that will be serviced by a Load-Fat for the current load instruction, is greater than the PRC 92 of any row of the CLAR 80, the current load instruction will be conducted as a Load-Fat during execution of the instruction per process block 84 using the storage structures 88 associated with the row of the CLAR 80 having the lowest PRC less than the CLC. In this way, a Load-Fat is conducted only if it doesn’t displace the data fetched by the previous fat loads that would likely service more load instructions, and the limited storage space of the CLAR 80 is best allocated to servicing those loads.

In completion of the Load-Fat per process block 84, a full cache line 55 (or region 54) is read from the L1 cache and stored in the CLAR 80 in the row identified above. In addition, the CLAR 80 is loaded with data for the CPTE 96 (from the TLB 23) and the RVA 94 (from the decoded addresses). The physical address in the CPTE 96 is compared against the physical addresses in the CPTE entries of the other CLAR rows to ensure there are no virtual address synonyms. If such synonyms exist, the Load-Fat is invalidated and a Load-Normal proceeds as discussed below.

In addition, prior to updating the CLAR 80 by a Load-Fat, the active count 97 is reviewed to make sure there are no current in-flight operations using that row of the CLAR 80. Again, if such operations exist, the Load-Fat is held from updating the row of CLAR 80 with the new fetched data until the in-flight operations reading the previous data in that row have read the data.

The PRC 92 in the selected row of CLAR 80 is set to the value of the CLC, and the ready bit 91 is set once the data is enrolled. Corresponding information is then added to the CMAP 72 including the bank 76 and the storage location identifier 78 for the loaded data, and the valid bit 74 of the CMAP 72 is set.

### Load-Normal

If, at decision block 83, the current load instruction is not categorized as a Load-Fat, a Load-Normal will be conducted per process block 100 in which a single word (related to the target memory address of the current load instruction) is fetched from the L1 cache 14 and loaded into a destination architectural register, or in an embodiment with an OOO processor, to a physical register 22 to which the architectural register is mapped via the register mapping table 31.

During either the Load-Fat of process block 84 or the Load-Normal of process block 100, the CPTE 96 entries of the rows of CLAR 80 may be reviewed at process block 110 to see if the necessary page table data is in the CLAR 80 for the page required by the normal load or fat load (regardless of whether the target data for the load instruction is in the CLAR 80). The page address of this data may be deduced from the RVA 94 entries. If a CPTE 96 for the desired page is in the CLAR 80, this data may be used in lieu of reading the TLB 23 (shown in FIG. 1), saving time and energy. For proper classification of a load instruction as a Load-CLAR, as per decision block 77 of FIG. 3c, data in the bank 76 and storage location identifier 78 in a row in the CMAP 72 need to accurately reflect the CLAR storage structure 88 containing the data for the memory address in the base register. If an instruction changes the contents of the base register, the data in the entries in the corresponding rows of the CMAP 72 need to be modified accordingly and possibly invalidated.

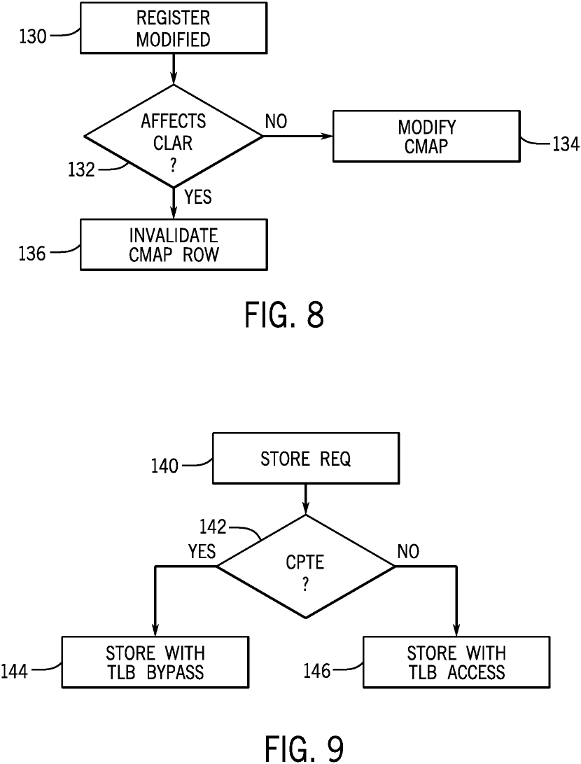

Referring now to FIG. 8, per process block 130, modifications to architectural registers are monitored. When a base register is modified, the modification is analyzed per decision block 132 to see if the current address pointed to by the modified register still lies within the cache line enrolled in the CLAR 80. This can be done in a decoding stage because it contemplates an analysis of instructions that change the contents of a base register in the CMAP 72 distinct from and before a load instruction where fat load assessment must be made. If the base register is changed, the appropriate data in the entries of the corresponding row of CMAP 72 are updated, for example, changing the storage location identifier 78. Thus, for example, if the location identifier for register R1 as depicted is s4 and at process block 130 a modification of the register R1 increments the value held by that register by one, the CMAP 72 may be simply modified per process block 134 to change the location identifier from s4 to s5 which does not affect the value or use of the stored cache line 55 in the CLAR 80. On the other hand, if the modification is to add 5 to the value of R1 (resulting in an effective location of s9 no longer in the cache line 55), the CMAP 72 can no longer guarantee that the data for the memory address in R1 is present in the CLAR 80, and the data of the CMAP 72 may be simply invalidated per process block 136 by resetting the valid bit 74 for the appropriate row.

### Bypassing the TLB

Referring now to FIG. 9, it will be appreciated that the stored CPTE 96 in the CLAR 80 may also be used to eliminate unnecessary access to the TLB 23 (shown in FIG. 1) during a store operation. In this procedure, before committing a store instruction, as indicated by process block 140, the availability of the CPTE 96 may be assessed according to the target memory address of the store instruction matching a page indicated by an RVA 94 entry in one of the rows of the CLAR 80. If that CPTE 96 is available, per decision block 142, it may be used to implement a storing indicated by process block 144 without access to the TLB 23. If the CPTE 96 is not available, a regular store per process block 146 may be conducted in which the TLB 23 is accessed.

Generally, it will be appreciated that the storage structures 88 of CLAR 80 may be integrated with the physical registers 22 of the processor 10. Further, the CMAP 72 may be simply integrated into a standard register mapping table 31 which also provides entries for each architectural register.

It will be appreciated that the above description considers the fat load as a single cache line from the L1 cache 14; however, as noted, the size of the fat load may be freely varied to any length above a single word including a half-cache line, a full cache line, or two cache lines.

### Additional Operation Details

### Mis-speculation

Since the CMAP 72 needs to point to the correct bank and storage structure 88 of the CLAR 80 for a given base architectural register, recovering the CMAP 72 in case of a mis-speculation can be complicated. Accordingly, entries in the CMAP and the CLAR banks may be invalidated on a mis-speculation of any kind. Other embodiments may include means to recover the correct entries of the CMAP.

### Handling Loads and Stores in an Out-of-Order Processor

In an out-of-order processor, stores may write into the cache when they commit, and loads can bypass values from a prior store waiting to be committed in a store queue. Memory dependence predictors are used to reduce memory-ordering violations, as is known in the art. With the present invention a load operation can dynamically be carried out as a different operation (normal loads, fat loads, and CLAR loads), and the data in the CLAR 80 needs to be maintained as a copy of the data in the cache 14. Accordingly, in one embodiment, stores write into the cache 14, but also into a matching location in the CLAR 80 when they commit (not when they execute). For normal loads, if there is a match in a store queue (SQ), the value is bypassed from the store queue, or else it is obtained from the L1 cache 14.

When a fat load proceeds to the L1 cache 14 per process block 84, checking the SQ to bypass a matching value is not done since that would result in the CLAR 80 and L1 cache 14 having different values. Rather, the fat load brings the cache line into the CLAR 80, and the matching store updates the data in the CLAR 80 and L1 cache 14 when it commits. Load-CLARs are entered into a load queue (LQ) associated with these processors even though they don’t proceed onward from the queue (and thus don’t check the SQ), so they participate in the other functionality (e.g., load mis-speculation detection/recovery, memory consistency) that the LQ provides.

Load-Fats and Load-CLARs can execute before a prior store. This early execution can be detected via the LQ and the offending operations replayed to ensure correct execution, just like early normal loads. To minimize the number of such replays, a memory-dependence predictor, accessed with the load PC which is normally used to determine if a load is likely to access the same address as a prior store, could be deployed to prevent the characterization of a load into a Load-CLAR or a Load-Fat; it would remain a normal load and execute as it would without CLAR 80, and get its value from the prior store.

### Cache Consistency

To allow for a load to be serviced from a storage structure of the CLAR 80, if early classification as a Load-CLAR is possible, or from the memory hierarchy otherwise, the values in the CLAR 80 and in the L1 cache14 and TLB 23 need to be kept consistent. From the processor side, this means that, when a store commits, the value must also be written into a matching storage structure of the CLAR 80 (and any buffers holding data in transit from the L1 cache 14 to the CLAR 80). Stores can also update the CLAR 80, partially changing a few bits in a storage structure 88. Wrong path stores don’t update the CLAR 80 in a preferred embodiment.

From the memory side, if an event updates the state relevant to a memory location from which data is in a CLAR 80, that location should not be accessible from the CLAR 80 (via a Load-CLAR). Accordingly, if data is invalidated, updated, or replaced in either the L1 cache 14 or the TLB 23 for any reason (e.g., coherence, activity, replacement, TLB shootdown), the corresponding data in the CLAR 80 and CMAP 72 are invalidated, preventing loads from being classified as Load-CLARs until the CLAR 80 and CMAP 72 are repopulated. An additional bit per L1 cache line/TLB entry, which indicates that the corresponding item may be present in the CLAR 80, can be used to minimize unnecessary CLAR 80 invalidation probes, for example, as described at R. Alves, A. Ros, D. Black-Schaffer, and S. Kaxiras, “Filter caching for free: the untapped potential of the store-buffer,” in Proceedings of the 46th International Symposium on Computer Architecture, 2019, pp. 436-448.

In multiprocessors with out-of-order processors, memory consistency is maintained using the Load and Store queues, which contain all the loads and stores in order, detecting problems and potentially squashing and restarting execution from a certain instruction. The same process can be used with Load-CLARs: they are loads that have executed “earlier” but their position in the overall order is known, and they can be restarted.

### System Hardware for Register Name Addressing

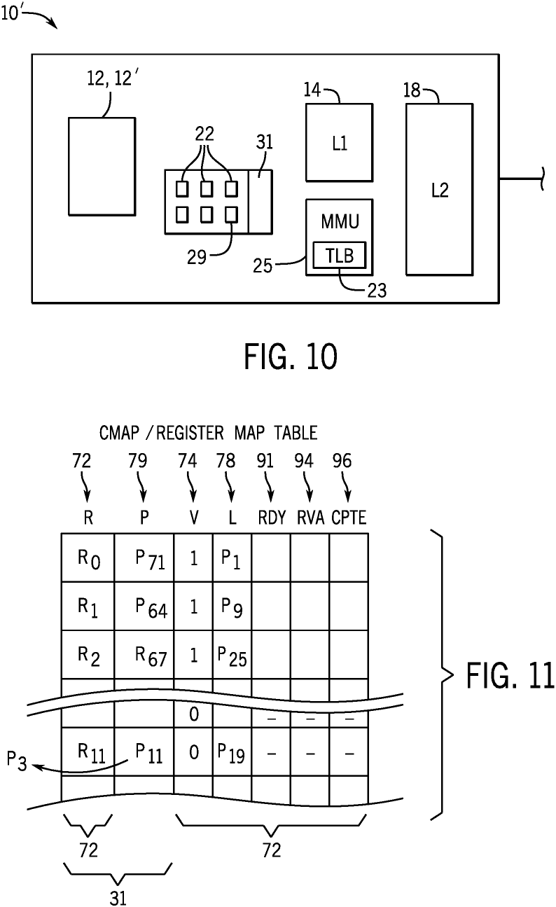

Referring now to FIG. 10, in one embodiment, the present invention may provide a processor 10', similar to the processor 10 described above with respect to FIG. 1, but not necessarily including the predictive load processing circuit 24 and thus optionally making some or even every load a fat load. In this processor 10', the function of the CMAP 72 may be incorporated into the register mapping table 31 and the CLAR 80 may be implemented using a plurality of banks of ordered physical registers 22. It will be appreciated from the following discussion, that this incorporation still provides the two separate functions of the CMAP 72 and register mapping table 31 but offers a savings in eliminating redundant information storage when physical registers 22 are used for storage of data of a fat load.

As before, and referring to FIG. 11, the CMAP 72 provides a logical row for each architectural register (R₀-R_{N}) of the processor 10', the architectural register name which may be used to index the CMAP 72. Importantly, in this embodiment, the CMAP 72 also incorporates the functionality of a register mapping table 31 linking architectural registers R to physical registers P. This register mapping function is provided (as represented diagrammatically) by a second column of physical register identifiers 79 identifying physical registers 22 and linking them to the architectural registers of the first column by a common row. Operations on the register mapping table 31 allow for data “movement” between a physical register P and an architectural register R to be accomplished simply by adjustment of the value of the physical register identifier 79 for architectural register R without a movement of data between physical registers.

Also, as before, a row of the CMAP 72 for an architectural register R has a valid bit 74 indicating that the row data with respect to the CLAR function is valid and a storage location identifier 78, in this case, being the name of a physical register 22 associated with previously loaded fat load of data from a fat load instruction using the given architectural register as a base register. This name of a physical register 22 will be used to evaluate later load instructions to see if the later load instruction can make use of the data of that fat load.

The CMAP 72 may also provide data that in the earlier embodiment was stored in the CLAR 80, including for each bank 76 of ordered physical registers, metadata associated with the stored data including a ready bit 91 (which must be set as a condition for data to be provided to the load instruction), a region virtual address RVA 94 indicating the virtual address corresponding to the stored cache line in the ordered physical registers of bank 76 and a corresponding page table entry (CPTE) 96 holding the page table entry from the translation lookaside buffer 23.

Referring now also to FIG. 12, banks 76 of ordered physical registers 22 operate in a manner similar to the storage structures 88 described above with respect to FIG. 7. In this example, multiple physical registers 22 form each bank 76 of the CLAR 80 as mapped to a region 54 (e.g., a cache line 55). In this example, a bank 76 provides eight physical registers (e.g., P0-P7 for bank B0) individually assigned to each of the eight words 57 of a cache line 55.

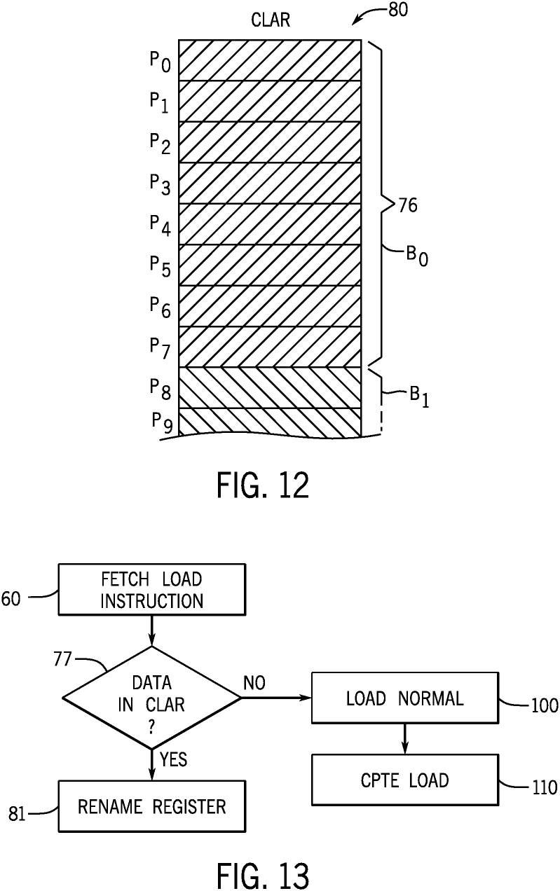

Referring now to FIG. 13, an example load instruction (LD R11, [R0], offset) may be received at process block 60. Per conventional terminology, R11 is a destination register indicating the register where the data of the memory load will be received, R0 is a base register name (the brackets indicate that the data to be loaded does not come from the R0 register but rather from a memory address designated by the contents of the R0 register), and “offset” is an offset value from the address indicated by R0 together providing a target memory address of the designated data of the load instruction. Each of these architectural registers R0 and R11 is mapped to an actual physical register by the register mapping table in CMAP 72 as discussed above.

Per decision block 77, (operating in a similar manner as decision block 77 in FIG. 3c) the name of the base register (R0), as opposed to its contents, is used to access the CMAP 72 of FIG. 11 to determine whether the necessary data to satisfy the load instruction is in the CLAR 80. In this example, there is an initial match with the first valid row of the CMAP 72 (indexed to R0) and the base register (R0) of the current load instruction. At decision block 77, the offset of the current load instruction is compared to the name of the physical register 22 in the storage location identifier 78 (P1) of the indicated row of the CMAP 72 to see if these two values are consistent with the target memory address of the data of the current load instruction, being in the memory region 54 in the bank 76 holding the physical register 22 indicated by storage location identifier 78. If the data is in the CLAR 80, per this determination, the program proceeds to process block 81 and if not, to process block 100 both described in more detail above with respect to FIG. 3c.

So, in this example, assuming that the physical register 22 identified by the storage location identifier 78 in the CMAP 72, associated with matching base register R0, is P1 and the offset value of the current load instruction is 2, the desired data will be in physical register P3 still within the designated bank 76 holding the physical register 22 (P1) of the storage location identifier 78 which extends from P0-P7, thus confirming that the necessary data is available in the CLAR 80. On the other hand, it will be appreciated that if the current load instruction has an offset value of 8, the desired load data would not be in the bank 76 of the CLAR 80 because P1+8=P9, a register outside of the bank 76 holding the physical register 22 (P1) indicated by the storage location identifier 78. Though this data may be present in some other bank 76 of the CLAR 80, the presence of the data in the CLAR 80 is not easily confirmed by consulting the CMAP 72 with the name of the base register (R0) of the load instruction.

In this regard, it is important to note that the original load instruction providing the fat load of data in the CLAR 80 may also have had an offset value. This offset value may be incorporated into the above analysis by separately storing the offset value in the CMAP 72 (as an additional column not shown) and using it and the name of the physical register 22 in the storage location identifier 78 to identify the name of the physical register 22 associated with the base register of the load instruction. For example, if the designated data of an original load instruction having an offset of 2 with a base register R0 was loaded into physical register P3 as part of a fat load, the CMAP 72 would have, in the row corresponding to R0, an offset value of 2 in the additional column (not shown), and a storage location identifier 78 indicating a physical register 22 of P3. Given this information, the above analysis would determine that the physical register 22 holding the data from the memory address in the base register R0 would be P3 - 2 = P1.

Alternatively, the additional column holding the offset value in the CMAP 72 can be eliminated by modifying the physical register 22 named by the location identifier 78. In the above example, the location identifier 78 stored in the CMAP would be modified at the time of the original fat load to read P1 rather than P3, indicating that the data from the memory address in the base register R0 has been loaded into P1 as part of the fat load of data.

An important feature of using physical registers 22 for the CLAR 80 is the ability to access data of the CLAR 80 in later load instructions without a transfer of data from the CLAR 80 to the destination register of the new load instruction. Thus, at process block 81 of FIG. 13, after data has been identified as existing in the CLAR 80, the destination register of the current load instruction may simply be remapped to the physical register of the CLAR 80. In the above example of a current load instruction (LD R11, [R0], 2), if the data necessary for this load instruction is found in P3 per the above example, there is no need to move the data from P3 to a physical register associated with R11 but rather R11 can be simply remapped to P3 (instead of P11) by rewriting the value of the physical register identifier 79 of R11 in the register mapping table 31. A similar approach can be used with respect to the operation described at FIG. 3c for process block 81.

It will be appreciated that the different components of these various embodiments may be combined in different combinations according to the above teachings, for example, using physical registers 22 and/or register mapping in the CMAP together with the predictive load processing circuit 24 to provide both fat and normal loads. Generally, the distinct functional blocks of the invention described above and as grouped for clarity, may share underlying circuitry as dictated by a desire to minimize chip area and cost.

The term “registers” should be understood generally as computer memory and not as requiring a particular method of access or relationship with the processor unless indicated otherwise or as context requires. Generally, however, access by the processor to registers will be faster than access to the L1 cache.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

1. An architecture of a computer processor operating in conjunction with a memory hierarchy to execute a program and comprising:
processing circuitry operating to receive a first and a second load instruction of the program, the load instructions of a type specifying a load operation loading a designated data from a memory region of the memory hierarchy to the processor; and
the processing circuitry further operating to process the first load instruction by loading from the memory hierarchy the designated data of the first load instruction to the processor and to process the second load instruction by loading from the memory hierarchy a fat load of data greater in amount than an amount of designated data of the second load instruction to the processor.

2. The architecture of claim 1 further including a prediction circuit operating to generate a prediction value predicting spatiotemporal locality of the data to be loaded by the first load instruction and the second load instruction; and
wherein the processing circuitry selects between a loading from the memory hierarchy of the designated data and a fat load of data based on the prediction values for the first and second load instruction received from the prediction circuit.

3. The architecture of claim 2 wherein the prediction circuit provides a prediction table linking multiple sets of prediction values and load instructions.

4. The architecture of claim 2 wherein the prediction circuit operates to generate the prediction value by monitoring spatiotemporal locality for previous executions of load instructions.

5. The architecture of claim 3 wherein the prediction circuit accesses the prediction table to obtain a prediction value for a load instruction using the program counter value of the load instruction.

6. The architecture of claim 5 wherein the prediction circuit uses a compressed representation of the program counter insufficient to map to a unique program counter value to access the prediction table.

7. The architecture of claim 2 wherein the prediction value for a given load instruction is based on a measurement of subsequent load instructions accessing a same fat load of data as the given load instruction in a measurement interval.

8. The architecture of claim 7 wherein the measurement interval is selected from the group consisting of: (a) a time between an execution of a given load and a completion of processing of the given load instruction; or (b) a number of instructions executing subsequent to the execution of the given load instruction; or (c) a number of clock cycles of the computer processor after the execution of the given load instruction;
wherein execution of the given load instruction corresponds to a time of determination of the memory region to be accessed by the given load instruction.

9. The architecture of claim 1 wherein the computer processor further includes a translation lookaside buffer holding page table data used for translation between virtual and physical addresses; and
wherein the processing circuitry processes the second load instruction to load both the fat load of data and translation lookaside buffer data to the processor.

10. The architecture of claim 1
wherein the processing circuitry further operates to receive a third load instruction of the program of a type specifying a load operation loading a designated data from a memory region of the memory hierarchy to the processor; and
wherein the processing circuitry further processes the third load instruction by providing designated data for the third load instruction to the processor from the fat load of data of the second instruction.

11. The architecture of claim 10 including multiple storage structures wherein the multiple storage structures provide a plurality of fat load areas holding fat load amounts of data;
and wherein each load instruction is associated with a base register having a name, a contents of the base register identifying an address in the memory hierarchy; and
a mapping table linking the name of a base register to a storage structure; and
wherein the processing circuitry selects a storage structure from among the multiple storage structures for the third load instruction using the name of the base register of the third load instruction.

12. The architecture of claim 11 where the processing circuitry includes a register mapping table mapping an architectural register to a physical register and wherein the multiple storage structures are physical registers mapped by the register mapping table; and
wherein the processing circuitry changes the register mapping table to link the selected physical register to a destination register of the third load instruction.

13. The architecture of claim 11 wherein a load instruction may be associated with an offset with respect to the base register;
and the mapping table links a base register name of the mapping table to a storage structure in a fat load area; and
wherein the processing circuitry compares an offset of the third instruction to a location in the fat area of the storage structure linked in the mapping table to confirm that the fat load of data of the second load instruction contains the designated data of the third load instruction.

14. The architecture of claim 13 wherein each fat load area of storage structures includes a set of named ordered registers providing the fat load area and the location in the fat load area is designated by a name of one of the set of named ordered registers.

15. The architecture of claim 11 wherein the data in a fat load area is linked with a count value indicating an expected spatiotemporal locality of the fat load of data with respect to future load instructions; and
wherein the processing circuitry operates to update the count value to indicate a reduced expected remaining spatiotemporal locality when a third load instruction is processed by the processing circuitry in providing the designated data from the data in the fat load area.

16. The architecture of claim 10 further including multiple storage structures wherein the multiple storage structures provide a plurality of fat load areas holding fat load amounts of data and linked with a count value indicating an expected spatiotemporal locality of a held fat load of data; and
wherein the processing circuitry further processes a fourth load instruction by loading from the memory hierarchy into one of the fat load areas a fat load of data greater than the designated data of the fourth load instruction; and
wherein the processing circuitry selects among the fat load areas for storage of the fat load of data of the fourth load instruction according to a comparison of the count value linked to each fat load area with a prediction value for the fourth load instruction, the prediction value indicating a likelihood of spatiotemporal locality between respective designated data and designated data of other load instructions.

17. The architecture of claim 1 wherein the amount of the designated data is a memory word and the amount of the fat load data is at least a half-cache line of a lowest level cache in the memory hierarchy.

18. A method of operating a computer processor communicating with a memory hierarchy to execute a program, the method including:
receiving load instructions from the program of a type describing a load operation loading a designated data to the processor from a memory region of the memory hierarchy;
processing a first load instruction by loading from the memory hierarchy the designated data of the first load instruction; and
processing a second different load instruction by loading from the memory hierarchy a fat load of data greater in amount than an amount of designated data of the second load instruction.

19. An architecture of a computer processor operating in conjunction with a memory to execute a program and comprising:
processing circuitry operating to receive a load instruction of the program, the load instruction of a type specifying: a load operation loading a designated data from a memory address of the memory to a destination register in the processor and a name of a base register holding memory address information used to determine the memory address in memory of the designated data for the load instruction;
a plurality of storage structures adapted to hold data loaded from a memory address of the memory;
a mapping table linking the name of a base register of a first load instruction to a storage structure holding data of a memory address of the memory, the memory address derived from a memory address information of the base register of the first load instruction;
wherein the processing circuitry further operates to match a name of a base register of a second load instruction to a name of a base register in the mapping table to determine if the designated data for the second load instruction is available in a storage structure.

20. The architecture of claim 19 wherein the storage structures are a set of registers accessible by a register name.

21. The architecture of claim 19 wherein the processing circuitry further processes the second load instruction by providing available designated data for the second load instruction to the processor from a selected storage structure.

22. The architecture of claim 21 wherein the storage structures are physical registers
and the processing circuitry includes a register mapping table mapping an architectural register to a physical register; and
wherein the processing circuitry changes the register mapping table to link the destination register of the second load instruction to a physical register providing the selected storage structure.

23. The architecture of claim 21 wherein a load instruction may be associated with an offset with respect to the base register;
and wherein the processing circuitry performs a comparison using an offset of the second instruction and the name of the base register of the second load instruction and information from the mapping table to confirm that the designated data of the second load instruction is held by a storage structure.

24. The architecture of claim 23 wherein the first and second load instruction both include an offset and the comparison uses both the offset of the first instruction and the offset of the second instruction and the name of the base register of the second load instruction and information from the mapping table to confirm that the designated data of the second load instruction is held by a storage structure.

25. The architecture of claim 19 wherein the processing circuitry determines if the designated data for the load instruction is available in the storage structure without accessing contents of the base register of the load instruction.

26. The architecture of claim 19 wherein when the processing circuitry determines that the designated data for the load instruction is not available in a storage structure; the processing circuitry obtains the designated data for the processor from the memory.

27. The architecture of claim 26 wherein the processing circuitry selects between obtaining from the memory a first amount of data holding the designated data and a second amount of data holding the designated data and other data and larger in amount than the first amount and storage of the second amount of data in the storage structure.

28. The architecture of claim 27 further including a translation lookaside buffer providing data translating between virtual addresses and physical addresses and wherein when the processing circuitry obtains the second amount of data it further loads translation lookaside buffer data for the designated data in the storage structure.

29. A method of operating a computer processor communicating with a memory to execute a program, the computer processor having a plurality of storage structures adapted to hold data loaded from a memory address of the memory and a mapping table linking the name of a base register to a storage structure holding data of a memory address of the memory the memory address derived from a memory address in the base register; the method including:
operating the processor to receive a load instruction of the program, the load instruction of a type specifying: a load operation loading a designated data from a memory address of the memory to a destination register in the processor and a name of a base register holding memory address information used to determine the designated data for the load instruction; and
further operating the processor to match the name of the base register of the load instruction to a name of a base register in the mapping table and to determine if the designated data for the load instruction is available in a storage structure.
